(19) United States
(12) Patent Application Publication
(10) Pub. No.: US 2014/0337435 A1
(43) Pub. Date: Nov. 13, 2014

(54) Device and Method for the Dynamic Load Management of Cloud Services

(71) Applicants: Gerald Kaefer, Munchen (DE); Anna-Sophie Schwanengel, Munchen (DE)

(72) Inventors: Gerald Kaefer, Munchen (DE); Anna-Sophie Schwanengel, Munchen (DE)

(21) Appl. No.: 14/365,201

(22) PCT Filed: Dec. 11, 2012
(86) PCT No.: PCT/EP2012/075050

§ 371 Date: Jun. 13, 2014

(30) Foreign Application Priority Data
Dec. 13, 2011 (DE) DE 102011088390.8

(51) Int. Cl. H04L 12/911; H04L 29/08

(52) U.S. Cl. CPC H04L 47/726; H04L 67/10
USPC 709/204

(57) ABSTRACT

The invention substantially relates to a device and a method for the dynamic load management of cloud services. At least one cloud service can be used by a service client, and the service client has a load management adapter which exchanges messages comprising reservation feedback with a service load manager, said service load manager exchanging additional messages in the form of an execution plan with the cloud service. In this manner, a minimum number of physical IT resources is achieved to the greatest degree possible while simultaneously complying with the service-level agreements agreed upon beforehand, and denial-of-service false alarms due to high peak loads are prevented. The invention can be advantageously used for optimizing a routing plan.

The invention relates to a method and a device for the dynamic load management of cloud services, in which the number of IT resources required is defined on the basis of an agreed Service Level Agreement (SLA).

The cloud service density provided by IT providers has been increasing for years. An attempt has previously been made to meet the requirement for the scalability of these cloud services by means of virtualization, replication and dynamic redistribution of virtual resources or physical resource allocation.

Although the use of cloud computing technology is setting new benchmarks in virtual resource redistribution and in the dynamic integration of physical resources, the problem remains of both the provision of the resources and the redistribution of virtual resources taking a particular minimum amount of time on the same hardware. These particular time constants cannot be undershot.

Dissemination in the industrial environment can also be foreseen from the widespread dissemination of these technologies.

However, in the industrial environment in particular, deterministic behavior is a basic requirement and resource availability must be able to be guaranteed for individual services even if they share a pool of physical hardware. In this case, there is still a high demand for automated and efficient response to a variable resource requirement.

Cloud services can be divided into two large categories, namely end user services with a user interface and interaction between the system and the person and machine-to-machine or service-to-service interfaces without human interaction, where the latter are easier to plan in terms of their IT resource requirement.

In addition to static IT resource management in which resources such as memory or computation power cannot be reserved for example, adaptive IT resource management, for example, is also known in which a system is automatically adapted to dynamic load changes on the basis of feedback from the transmission network, but the adaptation is possible only within certain limits on account of the SLAs.

Furthermore, dynamic IT resource management on the service side is known in which the number of IT resources required is determined with the service provider and empirical predictions are created on the basis of load patterns or the like and the course of the use of a service in a defined interval of time is determined thereby. Such an approach is also followed in SNAP. The protocol was developed by Foster et al. and is used to negotiate service level agreements and then coordinate resources in distributed systems on the basis of virtual machines.

In “Resource Allocation in the Grid with Learning Agents”, Galstyan et al. explain an algorithm for distributed dynamic resource division without a central control mechanism and without the inclusion of global information by means of “learning components”.

However, the disadvantage of dynamic IT resource management on the service side is, for example, the fact that, for a long-term prediction, evaluation of previously collected data is protracted and complicated or is perhaps impossible because the usage data are sometimes not available at all and, for a short-term prediction, fails for relatively large changes in the short interval of time since the time constant of dynamic IT resource management is typically in the minutes range.

The object on which the invention is based is now to specify a device and a method for the dynamic load management of cloud services, in which a minimum number of physical IT resources is achieved as far as possible while simultaneously complying with the previously agreed service level agreements and denial-of-service false alarms caused by large peak loads and the above-mentioned disadvantages are avoided as far as possible.

This object is achieved according to the invention, in terms of the method, by the features of patent claim 1 and, in terms of the device, by the features of patent claim 7. The further claims relate to preferred refinements of the invention.

The invention substantially relates to a device and a method for the dynamic load management of cloud services, in which at least one cloud service can be used by a service client and the service client has a load management adapter which interchanges messages containing reservation responses with a service load manager which in turn interchanges further messages in the form of an execution plan with the cloud service. A minimum number of physical IT resources is achieved as far as possible thereby while simultaneously complying with the previously agreed service level agreements and denial-of-service false alarms caused by large peak loads are avoided. The invention can be advantageously used to optimize route planning.

The invention is explained in more detail below using exemplary embodiments illustrated in the drawing, in which:

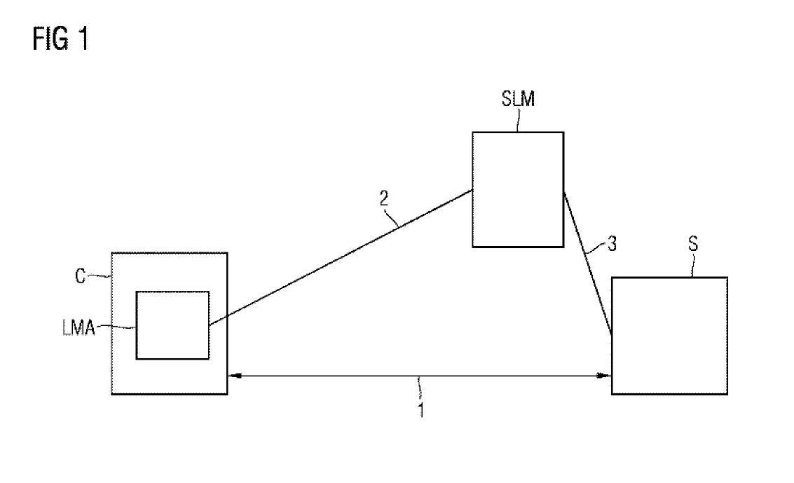

FIG. 1 shows an illustration for explaining the relationships between the service client, the service load manager and the cloud service of a device according to the invention,

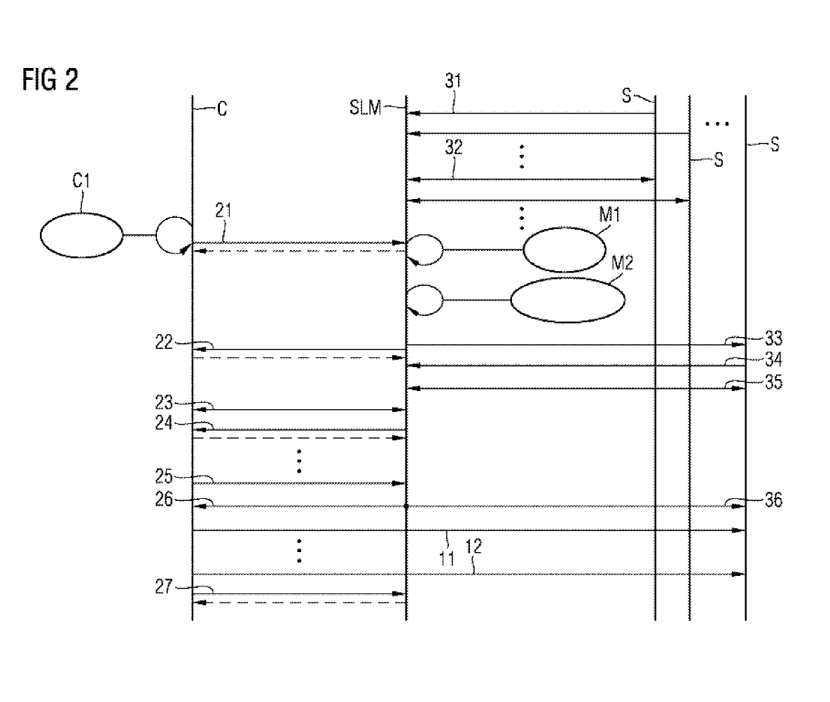

FIG. 2 shows a possible implementation of a corresponding communication model,

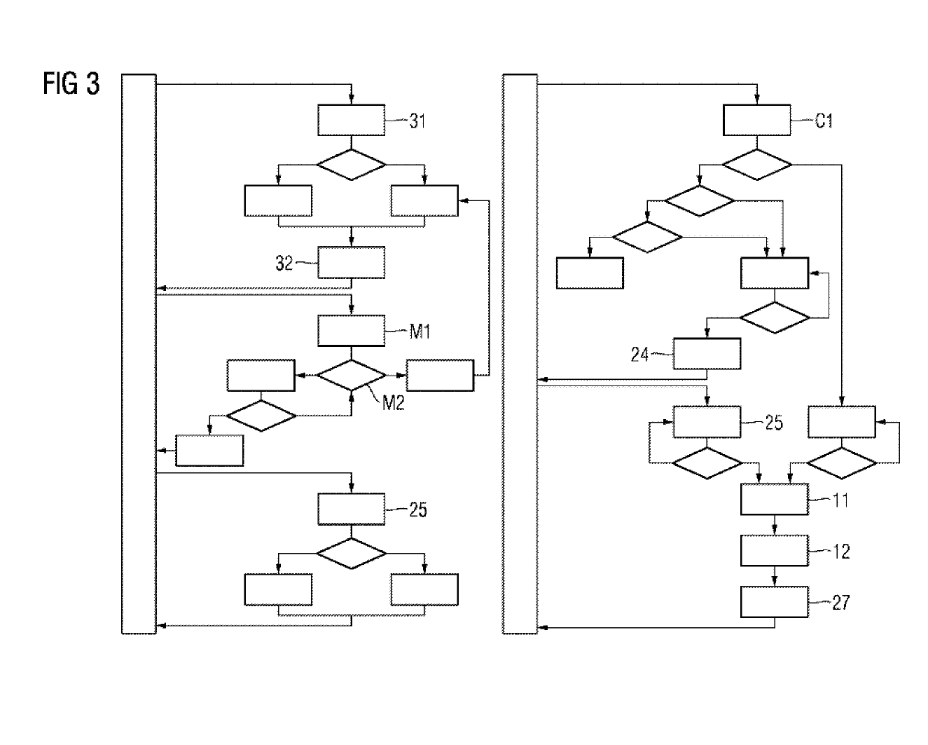

FIG. 3 shows execution models for illustrating the actions in the service load manager and in the client in an exemplary manner,

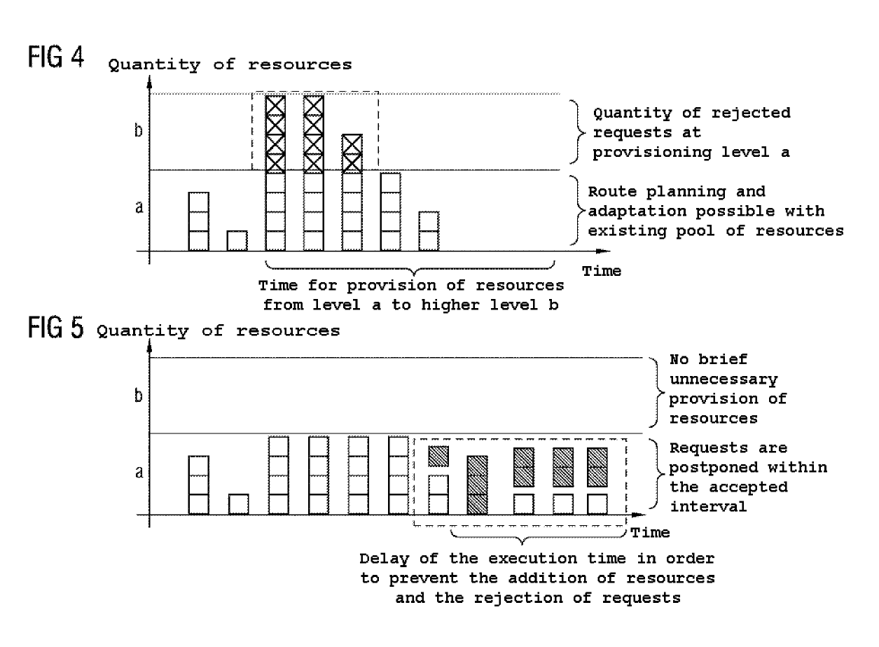

FIG. 4 shows an illustration of temporal resource assignment without load management for an application, and

FIG. 5 shows an illustration of the temporal resource assignment with load management for the same application.

FIG. 1 illustrates a service client C and a cloud service S which are connected via a service use 1, the service client C having a load management adapter LMA which is connected to a service load manager via resource reservation responses 2, and the service load manager SLM being connected to the cloud service S via an execution plan (schedule) 3 for the provision of resources.

FIG. 2 shows a communication model which stipulates how the system participants communicate in the event of a peak load and which messages are interchanged in what manner in this case. The individual services S, that is to say a calculation service, a storage service, a message service, first of all register 31 with the service load manager SLM and negotiate 32 the conditions of use in the form of service level agreements (SLA). The service load manager SLM now waits for incoming requests 21 from clients. The requirement C1 identified by the client, including a deadline, is communicated to the service load manager SLM which aggregates Ml the requests from all clients and checks M2 the possibility of covering the registered requirement with the aid of the resources which have already been registered. In the event of an overload, that is to say if the registered requirement cannot be covered with the aid of the resources which have already been registered, the service load manager SLM requests 33 new resources, for example virtual machines, and reports 22 this to the client C, including a proposed delay as regards when the new resources are available. The conditions of use must be negotiated 23, 35 between the client C and the SLM and the service S in accordance with the requirements. If there are sufficient resources available and in the event of positive agreement, the resources are reserved 24 and the client C can use 11 the resources for the registered duration at the booked time. The client requests 25 the corresponding resource from the service load manager SLM for this purpose, whereupon the service load manager SLM connects 26, 36 the service S and the client C. After successfully using 11 the service, the client C releases 12 the service S again and reports 27 this to the service load manager SLM which can now include the free resource in its planning again.

FIG. 3 shows an execution model which stipulates how the service load manager SLM and the client C act and react before, during and after interchanging messages and what typically happens inside the components in this case.

The functions of the individual components from FIG. 1 are now described in more detail below using the models from FIGS. 2 and 3.

### Service Client:

The service client C first of all identifies C1 its requirements. If its requirement must be covered immediately, it immediately requests 22 the resources from the service load manager SLM. In the event of a positive response, that is to say if there are sufficient resources, it can connect 26, 36 to the service and, after using 11 the service, can finally release 12 the service again and can accordingly inform 27 the service load manager SLM of the release. If the client decides to send a reservation to the service load manager SLM in advance, it requires accordingly identified load patterns and histories. If such load patterns and histories are available, a reservation request 22 can be sent. If pattern recognition has not yet been carried out but would be possible on the basis of collected data, a pattern is generated and a reservation is then sent. After receiving a confirmation response (acknowledge) relating to the reservation, the client can call 25 the resource from the service load manager SLM at the agreed time and can then use 11 the service and accordingly release 27 it.

The dynamic resource management method can be optionally used by the service client C. The compatibility with already existing service clients is therefore maintained.

### Service Load Manager:

If a service registration 31 arrives at the service load manager SLM, the latter checks whether there is already a corresponding service ID in the directory. If this is the case, a connection to the service is set up and the SLAs are negotiated with the latter. If, on the other hand, there is a new registration 31 of the service, it is stored in the register and the SLAs are then negotiated 32 again. If necessary, the SLM aggregates M1 the client requests and checks M2 whether the total requirement can be covered. For this purpose, it includes the planned times and the significant intervals of time in its resource planning. If the current resources do not suffice, new resources are requested 33. If the requirement can be covered with the existing resources, the conditions of use are negotiated 35 with the client until an agreement has been reached and the resources can be reserved. If the client requests resources, the SLM first of all always checks whether there is a corresponding reservation by the client. In this case, the client is connected 26, 36 to the corresponding service. If the client has not registered a reservation, either because the protocol is not supported or because no pattern was available for prediction, the client is rejected in the event of overload so that the reserved resources are available for the requesting service clients supporting the protocol. If a service client SC which supports the resource management protocol suddenly requests resources which have not been reserved by the client and there are currently no free resources available either, it is informed that it is placed toward the back of a queue as part of its shift interval.

### Cloud Service:

The cloud services S register 31 with the service load manager SLM and therefore provide their services for requesting clients C. A respective cloud service S must integrate the resource control from the service load manager SLM and must create an execution plan (schedule) 3 for the provision of resources. For this purpose, planned times and possible intervals of time for using the resources are interchanged with the service load manager SLM and a schedule 3 for execution is created in consultation. This schedule can then be optimized according to the requests in order to achieve high utilization of the resources. Unnecessary empty states or gaps in the execution plan are therefore avoided and waste of resources is largely prevented.

### Protocol Description:

An information model describes which information is transported by the messages and stipulates a message format. This comprises information relating to:
Client ID: unique identification of a client for preventing false DoS alarms.
Manager ID: unique identification of the manager replicas for scalability.
Service ID: for describing the service to be actually used by the client.
SLA-ID: categorization of the negotiated SLAs.
Resource requirement: definition of the quantity of resources required by the client.
Starting time: for indicating the start of use.
Duration of Use: for indicating the usage duration.
Proposed delay: proposed waiting time of the manager component until the resource is available.
Deadline: maximum accepted delay.

### ADVANTAGES OF THE INVENTION

Proactive reservation of an IT resource requirement by the service user with the service load manager makes it possible for the latter to determine the resource requirement for the entire load over time in advance. This requirement is then taken into account in IT resource management in order to be prepared for known peak loads and to smooth possibly unexpected peak loads. The physical resources required can therefore be used as efficiently as possible.

The reservation of the service user's requirement and the associated unique identification of the user make it possible for the intrusion detection system to be informed of a high usage requirement in advance and said system therefore does not unintentionally block the service user. False warnings with respect to denial-of-service attacks can therefore be prevented.

The service is able to influence the service user during the actual use of the service by said user by scheduling a client request in the allowed interval of time. The aggregated IT resource requirement of all service users can therefore be optimized in order to provide the service. The optimization of the schedule then makes it possible to provide the service for all users with a more constant quantity of IT resources, which minimizes costs.

In the event of a brief overload, the service user can be temporally delayed within the scope of the SLAs in order to be able to provide new resources in the interim. The service user is not rejected with a fault message but rather is informed of the brief delay and

therefore does not produce any unnecessary additional load as a result of repeat requests which would be produced without this feedback.

The service can serve both service users who support the load management protocol and service users who do not support said protocol. The difference in handling is that, in the event of a brief overload, the protocol-supported users are served and the others are rejected.

### EXAMPLE OF AN ADVANTAGEOUS USE OF THE INVENTION

The device according to the invention can be advantageously used to optimize route planning. In the case of such a route planning service, the route should be planned dynamically on the basis of the current traffic situation.

In this case, the service client C is specified as the logistics service client, the cloud service S is specified as the route planning service here and the service use 1 is specified as the route planning and dynamic adaptation.

For example, the client load management adapter LMA and the service load manager SLM can interchange information relating to resource reservation and feedback information.

The service load manager SLM and the route planning service S can agree with respect to resource allocation in this case.

After this, the logistics service client C can itself use the route planning service S. They are therefore autonomous spontaneous users and participants in a logistics company, for example. For a logistics planning service, it is enormously important which route is selected to deliver goods since efficient scheduling is decisive for quality. A logistics planning process corresponds to the determination of distances between individual destinations. A route can be optimized therefor on the basis of the goods.

FIG. 4 illustrates the temporal resource assignment without load management for this application, in which case a higher level b of resource provision is required within an interval of time and the resource requests above a particular provisioning level a are rejected.

As can be seen in FIG. 4, rejections would be made in the event of a high request density. The calculation of new routes or else necessary dynamic adaptations of calculated routes on the basis of new traffic messages, for example, are not possible without corresponding implementation of the invention.

In contrast, FIG. 5 illustrates the temporal resource assignment with load management according to the invention likewise for this application, in which case requests within an accepted interval of time are postponed in order to thereby prevent addition of resources and rejection of requests.

The use of the device according to the invention means, on the one hand, that a logistics service client C can plan a journey and can already reserve particular resources in advance in order to be reliably served at the desired execution time. On the other hand, a “long-term” logistics planning process, that is to say a logistics planning process which lasts for a comparatively long time, can be temporarily moved back in order to prevent rejection and restarting of resources. This results in uniform resource utilization, as can be seen in FIG. 5.

1. A device for the dynamic load management of cloud services,
in which at least one service (S) can be used (1, US) by a service client (C),
in which the service client (C) has a load management adapter (LMA) which interchanges messages (2) with a service load manager (SLM), and
in which the service load manager (SLM) in turn interchanges further messages (3) with the cloud service (S).

2. The device as claimed in claim 1,
in which the service load manager (SLM) is present such that
it checks, if a service registration (31) arrives at it, whether there is already a corresponding service ID in a directory,
it sets up a connection to the service and negotiates the SLAs with the latter if there is already a corresponding service ID in the directory and otherwise also previously newly registers (31) the service (S),
it aggregates (M1) client requests, if necessary, and checks (M2) whether the total resource requirement can be covered,
it requests (33) new resources if the current resources do not suffice and otherwise negotiates (35) the conditions of use with the client (C) until an agreement is reached and the resources are reserved,
it first of all always checks, if the client (C) requests resources, whether there is a corresponding reservation by the client, and the client is connected (26, 36) to the corresponding service in this case,
it is rejected in the event of overload if the client has not registered a reservation, and
it is informed, if a client (C) suddenly requests resources which have not been reserved by the client and there are currently no free resources available either, that it is placed toward the back of a queue as part of its shift interval.

3. The device as claimed in claim 1 or 2,
in which the service client (C) is present such that
it first of all identifies (C1) its requirements and, if its requirement must be covered immediately, immediately requests (22) the resources from the service load manager SLM,
it connects (26, 36) to the service if it receives the response that there are sufficient resources and, after using (11) the service, finally releases (12) the service again and informs (27) the service load manager SLM of the release,
it checks, if it decides to send a reservation to the service load manager (SLM) in advance, whether or not there are corresponding identified load patterns and histories and, if such load patterns and histories are available, sends a reservation request and, if pattern recognition has not yet been carried out but would be possible on the basis of collected data, generates a pattern and then sends a reservation, and
it calls (25) the resource from the service load manager (SLM) at the agreed time after receiving a confirmation response (24) relating to the reservation and then uses (11) the service (S) and then accordingly releases (27) the service again.

4. The device as claimed in one of claims 1 to 3,
in which at least one cloud service (S) is present such that
it registers (31) with the service load manager (SLM) and thus provides its services for at least one requesting client (C), and
it integrates the resource control from the service load manager (SLM) and creates an execution plan (3) for the provision of resources, in which case planned times and possible intervals of time for using the resources are interchanged with the service load manager (SLM) for this purpose
and the execution plan (3) is created in consultation.

5. The device as claimed in claim 4,
in which the execution plan (3) is optimized in accordance with the requests in such a manner that gaps in the execution plan (3) are avoided.

6. The device as claimed in one of the preceding claims,
in which the messages (2) and/or the further messages (3) comprise the following information:
“client ID” for uniquely identifying a client,
“manager ID” for uniquely identifying the manager replicas,
“service ID” for describing the service to be used by the client,
“SLA-ID” for categorizing the negotiated SLAs,
“resource requirement” for defining the quantity of resources required by the client,
“starting time” for indicating the start of use,
“duration of use” for indicating the usage duration,
“proposed delay” corresponding to a proposed waiting time of the manager component until the desired resource is available, and
“deadline” which is a maximum accepted delay.

7. A method for the dynamic load management of cloud services,
in which the at least one service client (C) reserves (2) a requirement, and
in which at least one cloud service (S) influences (2, 3) user behavior (1) of the service client (C) within the scope of the previously agreed possibilities of the service level agreement.

8. The method as claimed in claim 7,
in which the at least one service (S) first of all registers (31) with the service load manager (SLM) and
negotiates (32) the conditions of use in the form of service level agreements,
in which the service load manager (SLM) waits for incoming requests (21) from at least one service client (C),
in which a requirement (C1) identified by this at least one service client, including a deadline, is communicated to the service load manager (SLM) which aggregates (M1) the requests from all clients and checks (M2) whether the registered requirement can be covered with the aid of the resources which have already been registered,
in which, in the event of an overload, the service load manager (SLM) requests (33) new resources and reports (22) this to the service client (C), including a proposed delay as regards when the new resources are available,
in which the conditions of use are negotiated (23, 35) between the at least one service client (C) and the service load manager (SLM) and the respective service (S) in accordance with the requirements,
in which, if there are sufficient resources available and in the event of positive agreement, the resources are reserved (24) and the at least one service client (C) uses (11) the resources for the registered duration at the booked time, this service client (C) requesting (25) the corresponding resource from the service load manager (SLM) for this purpose, whereupon the service load manager (SLM) connects (26, 36) the service (S) and this service client (C), and
in which, after successfully using (11) the service, the at least one service client (C) releases (12) the service (S) again and reports (27) this to the service load manager (SLM) which now includes the free resource in its planning again.
